(19) United States
(12) Patent Application Publication
(10) Pub. No.: US 2015/0022294 A1
(43) Pub. Date: Jan. 22, 2015

(54) DRIVE FOR A TAP CHANGER

(71) Applicants: Christian HURM, Regensburg (DE); Karsten VIERECK, Regensburg (DE); Maschinenfabrik Reinhausen GmbH, Regensburg (DE)

(72) Inventors: Christian Hurm, Regensburg (DE); Karsten Viereck, Regensburg (DE)

(21) Appl. No.: 14/364,965

(22) PCT Filed: Jan. 15, 2013
(86) PCT No.: PCT/EP2013/050627

§ 371 Date: Jun. 12, 2014

(30) Foreign Application Priority Data
Feb. 23, 2012 (DE) 20 2012 100 603.0

(51) Int. Cl. H01H 3/32

(52) U.S. Cl. CPC H01H 3/32
USPC 335/187

(57) ABSTRACT

The invention relates to a drive unit for a step switch for actuating switch contacts. The problem addressed by the invention is that of providing a drive unit for a step switch which is arranged closer to the step switch, guarantees a fast and safe actuation of the step switch and also has a compact design. The problem is solved by a drive unit which consists of a lift magnet arranged directly on the switch contact, which opens or closes the switch contact by applying a voltage.

The invention relates to a drive for a tap changer for actuating switch contacts.

As is known from DE 19816543 use is usually made of motor drives for operating tap changers. Despite the co-operation of motor drive and tap changer, these are arranged to be physically separate. The tap changer itself is, apart from the upwardly protruding tap changer head, placed in the transformer vessel, whereas the motor drive is arranged outside the transformer, usually at the outer wall thereof. The connection between motor drive and tap changer is effected by way of a shaft train that consists of individual shafts, couplings and joints.

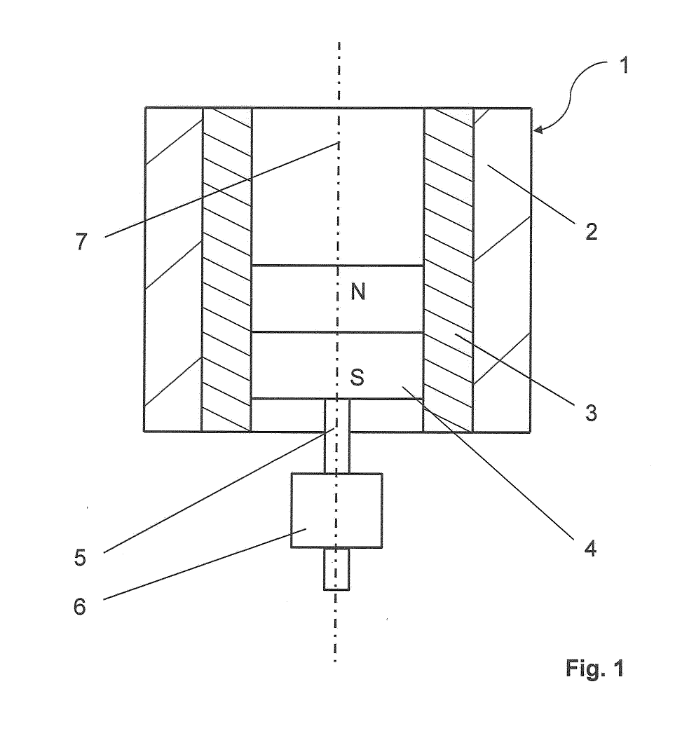

In addition, the general principle of actuation of the tap changer by means of a motor drive is known from FIG. 1 in DE 10119664 [U.S. Pat. No. 7,449,851]. The motor drive arranged externally at the transformer housing actuates the tap changer by way of drive shafts. The control of the motor drive in that case is carried out with the help of a voltage regulator that determines the control commands by constant comparison of actual and target voltages at the transformer.

An alternative actuating device for a vacuum-switching tube is known from U.S. Pat. No. 8,040,210 B2. In that regard, a switch contact of a vacuum-switching tube is connected at the protruding end with a movable core. The axial direction of movement of the core corresponds with the opening and closing movement direction of the switch contact of the vacuum-switching tube. During opening and closing, the core moves between two end positions at each of which a coil able to be acted on by current is arranged. Through selective application of voltage to one of the coils a force is induced, the core is moved and the vacuum-switching tube is opened or closed.

A substantial disadvantage in the case of the drives known from the prior art resides in the load and control transmissions that are used. The connection of these individual transmissions with one another is complex as well as time-consuming and cost-intensive. In addition, the use of simple three-phase induction motors as drive means is accompanied by disadvantages. Thus, it is very difficult and, above all, cost-intensive to procure three-phase induction motors with constant key performance data. The inhomogeneity of the parameters of the three-phase is induction motors requires additional sensors or individually adapted transmissions. In addition, the drive trains represent a significant source of fault. The couplings serving to interconnect the shafts wear with time and cannot guarantee secure and reliable functioning. Small play of the individual parts accumulates over the entire drive train and forms substantial deviations at the end, namely at the tap changer.

In addition, the actuation of the vacuum-switching tubes by means of a core arranged between two coils able to be acted on by voltage is accompanied by disadvantages. Apart from the need for space that two coils have, a complex control is necessary in order to move the core and actuate the vacuum-switching tube.

The object of the invention is thus to provide a drive for a tap changer that is arranged close to the tap changer, guarantees a rapid and reliable actuation of the tap changer and in that case is of compact construction.

The object is fulfilled by a drive for tap changers according to the features of the first patent claim. The respective subclaims relate to further advantageous developments of the invention.

The object is fulfilled by a drive for tap changers that consists of a stroke magnet that is arranged directly at the switch contact and that through application of a voltage opens or closes the switch contact.

The invention is explained in more detail in the following by way of figures, in which:

FIG. 1 shows a drive for a tap changer,

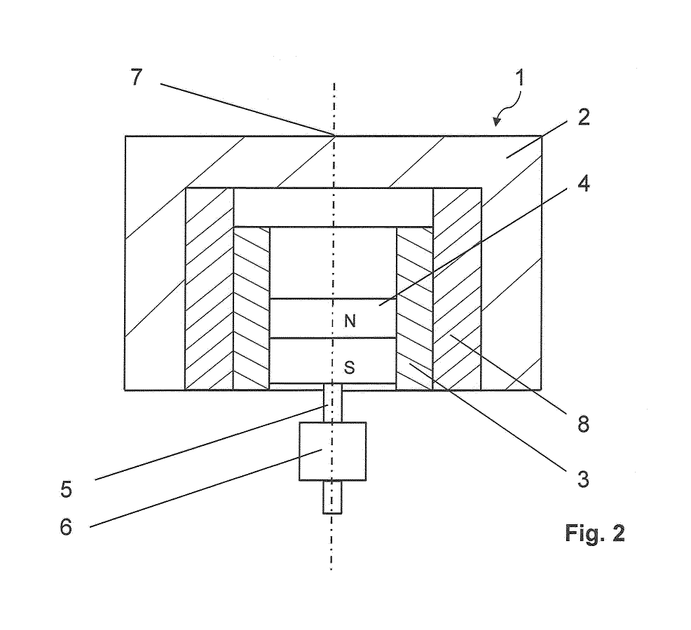

FIG. 2 shows a form of embodiment of the drive with two coils,

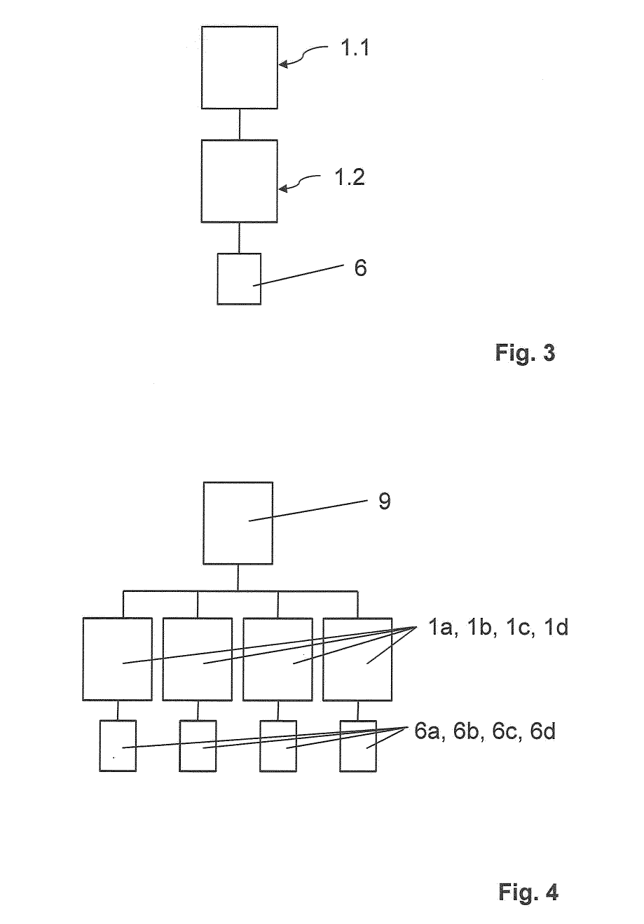

FIG. 3 shows two drives connected in series,

FIG. 4 shows a special connection of drives,

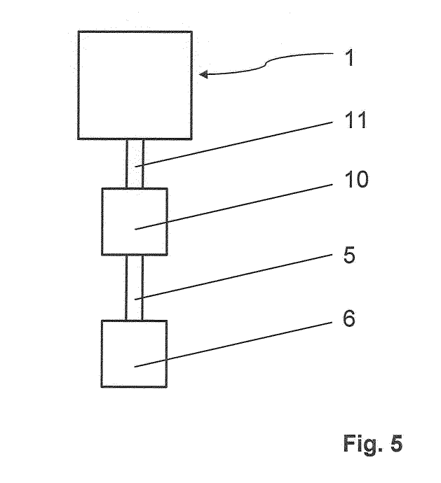

FIG. 5 shows a drive with a coupling element,

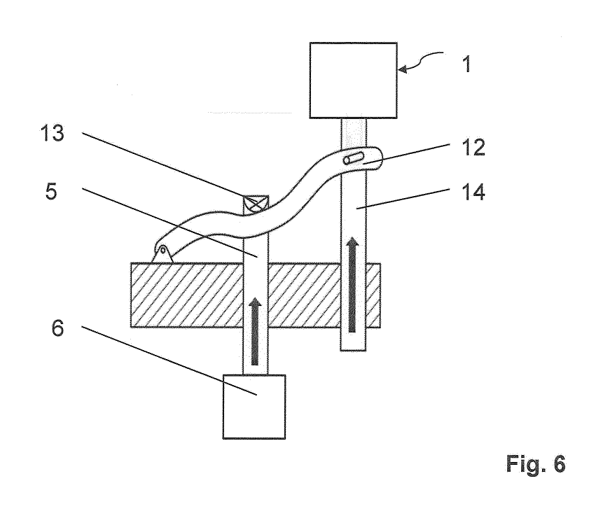

FIG. 6 shows a drive with indirect actuation of a switch contact by way of a guide, and

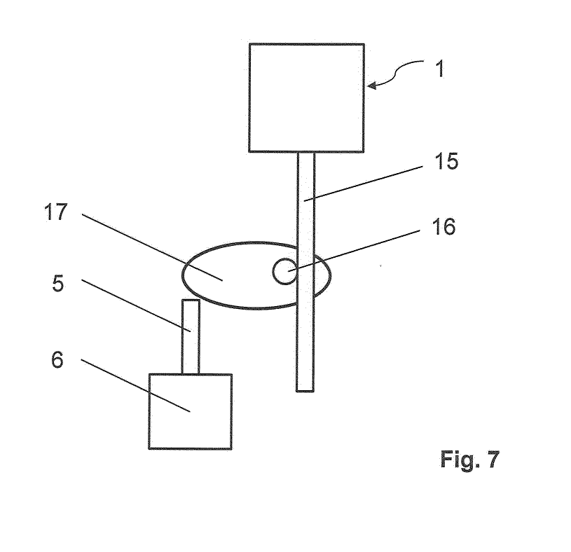

FIG. 7 shows a drive with indirect actuation of a switch contact by way of a rack and a cam.

A drive 1 for a tap changer with a housing 2, a coil 3 and an armature 4 is depicted in FIG. 1. The coil 3 is fixedly mounted in the housing 2 and is electrically conductively connected with a voltage source (not illustrated here). The armature 4 is so arranged in the housing 2 that it is at least partly surrounded by the coil 3. The armature 4 is constructed as a magnet and has a north pole and a south pole. The armature 4 preferably consists of a material that is difficult to demagnetize, such as, for example, a samarium-cobalt alloy or a neodymium-iron-boron alloy.

The armature 4 is additionally mechanically connected at an end with a switch contact 6 by way of a connecting member 5. The switch contact 6 can be opened or closed by way of the connecting member 5. The switch contact 6 can be realized by, for example, a vacuum-switching tube, a mechanical contact or similar.

In addition, the actuation of several switch contacts 6 by means of one drive 1 is possible. For that purpose the connecting member 5 would have to be adapted to the respective number of switch contacts 6 to be actuated.

Through application of an electrical voltage to the coil 3 a directional current flows therethrough; in that case, a magnetic field arises. This magnetic field in the coil exerts on the armature 4 a force by means of which the armature 4 is set into motion. The direction of movement of the armature 4 depends on the direction of the current flow and takes place linearly along an axis 7 of symmetry. The movement of the armature 4 thus leads to opening or closing of the switch contact 6 and is thus dependent on the flow direction of the electric current.

FIG. 2 shows one possible form of embodiment of the drive 1 for tap changers, in which the first coil 3 at least partly surrounding the armature 4 is not fixedly arranged in the housing 2, but is at least partly surrounded by a coil 8. In that case the coils 3, 8 are mechanically connected together. The first coil 3 can thereby be used as an armature and similarly execute a linear movement along the axis 7 of symmetry. This is primarily necessary when the force generated by the first coil 3 is not sufficient for opening the switch contact 6.

FIG. 3 shows a further form of embodiment of the invention, in which a first drive 1.1 is arranged behind a second drive 1.2 and the two actuate a switch contact 6. The two drives 1.1, 1.2 have different characteristic values with respect to stroke height and/or stroke force, but function according to the same principle as the drive 1 of FIG. 1. Different phases of an opening or closing process can be controlled by this advantageous form of embodiment. A further connection possibility of the drive 1 is depicted in FIG. 4. Each switch contact 6a, 6b, 6c, 6d is connected with a separate drive 1a, 1b, 1c, 1d. In addition, all drives 1a, 1b, 1c, 1d are connected with a further, significantly larger drive 9. The drive 9 shall primarily be used as assistance and, for example, come into use in the case of welded switch contacts, thus as a form of safety element.

In the case of the form of embodiment depicted in FIG. 5, a coupling element 10 is arranged between the drive 1 and the switch contact 6. This functions according to the impact principle and is particularly suitable for detaching stuck or welded switch contacts 6. In that case, the drive 1 is mechanically connected with the switch contact 6 by way of a coupling ram 11, the coupling 10 and the connecting member 5. The movement is transmitted to the coupling ram 11 when the drive 1 is actuated. Since this has a freewheel, initially there is still no actuation of the switch contact 6. At the end of the freewheel, a pulse is generated by way of the coupling 10 due to the suddenly arising resistance. This pulse is transmitted to the switch contact 6 and detaches the welded and stuck places in the switch contact 6. The pulse strength can be varied in dependence on the respective size of the freewheel.

FIG. 6 shows a further form of embodiment of the invention. In this case, drive 1 and switch contact 6 are in indirect mechanical connection by way of a guide 12. The connecting member 5 has at the upper end a cam 13 that scans the profile of the guide 12 and thus actuates the switch contact 6. In addition, the guide 12 is mechanically connected with the drive 1 is by way of a connecting element 14. Through actuation of the drive 1 the guide 12 is moved by way of the connecting element 14. The switch contact 6 is actuated by the connecting member 5 by way of the profile of the guide 12 and the cam 13.

A further form of embodiment in which the drive 1 is a rack 15 is depicted in FIG. 7. This rack is mechanically connected with a pinion 16 and thus converts the linear movement of the rack 15 into a rotational movement. The pinion 16 is additionally connected with a cam 17 that, through rotation, actuates the switch contact 6 via the connecting member 5.

It is particularly advantageous with the invention that the individual drives are actuatable independently of one another and thereby complex switching sequences can be realized. Also positive is the omission of the numerous transmissions as well as shafts. The simplified construction and the no longer necessary individual parts simplify production and reduce costs. In addition, the effects of wear of individual parts lose significance due to reduction of the drive to just a few components. Exchange of defective or worn components can be carried out more rapidly and more selectively.

The drive can be of particularly compact design through the use of a ferromagnetic armature, since only one coil is needed and the movement direction of the armature depends on the polarity of the applied voltage. Control of the polarity of the voltage can be realized very simply and economically. Since the armature consists of a special material or alloy that is difficult to demagnetize this retains its ferromagnetic characteristic even at high temperatures. This increases the field of use of the invention.

### REFERENCE NUMERALS

1 drive

1.1 first drive

1.2 second drive

1a, 1b, 1c, 1d drive

2 housing

3 first coil

4 armature

5 connecting member

6 switch contact

6a, 6b, 6c, 6d switch contact

7 axis of symmetry

8 second coil

9 drive

10 coupling element

11 coupling ram

12 guide

13 cam

14 connecting element

15 rack

16 pinion

17 cam

1. A drive for a tap changer for actuating at least one switch contact, wherein
the drive consists of a housing, an electrical coil and a ferromagnetic armature,
the ferromagnetic armature is at least partly surrounded by the coil,
the coil is mechanically connected with the housing.
the ferromagnetic armature is mechanically connected with the at least one switch contact,
the ferromagnetic armature is arranged to be movable along an axis of symmetry and
the coil can, for actuation of the at least one switch contact, be acted on at least periodically by electrical voltage of selectably different polarity in such a manner that the direction of movement of the ferromagnetic armature is determinable by the polarity of the applied electrical voltage.

2. The drive for a tap changer for actuating at least one switch contact according to claim 1, wherein the coil is at least partly surrounded by a second coil, the coil is mechanically connected with the second coil, and the coil is arranged to be movable along the axis of symmetry.

3. The drive for a tap changer for actuating at least one switch contact according to claim 1, wherein at least two drives are connected in series with the switch contact.

4. The drive for a tap changer for actuating at least one switch contact according to claim 3, wherein several separate drives are each connected in parallel with a respective switch contact and can be actuated simultaneously by a larger, common drive.

5. The drive for a tap changer for actuating at least one switch contact according to claim 1, wherein at least one coupling element is arranged between a drive and the at least one switch contact and the coupling element functions in accordance with the impact principle.

6. The drive for a tap changer for actuating at least one switch contact according to claim 1, wherein the drive actuates at least one switch contact indirectly by way of a guide.

7. The drive for a tap changer for actuating at least one switch contact according to claim 1, wherein the drive actuates a rack mechanically connected with a pinion, the pinion is mechanically connected with a cam and the cam actuates at least one switch contact directly or by way of a connecting member.

8. The drive for a tap changer for actuating at least one switch contact according to claim 1, wherein the at least one switch contact is a vacuum-switching tube or mechanical contact.

9. The drive for a tap changer for actuating at least one switch contact according to claim 8, wherein several vacuum-switching tubes are combined to form a single switch contact.

10. The drive for a tap changer for actuating at least one switch contact according to claim 1, wherein the ferromagnetic armature consists of a material difficult to demagnetize or a samarium-cobalt alloy or a neodymium-iron-boron alloy.
